(19) United States
(12) Patent Application Publication
(10) Pub. No.: US 2006/0248405 A1
(43) Pub. Date: Nov. 2, 2006

(54) Method for automating unit test development

(76) Inventors: Joseph M. Ponczak, Owings Mills, MD (US); John M. Miller, Baltimore, MD (US)

Correspondence Address: Ober, Kaler, Grimes & Shriver;Attorneys at Law, 120 East Baltimore Street, Baltimore, MD, 21202-1643, US

(21) Appl. No.: 11/385,252

(22) Filed: Mar. 21, 2006

Related U.S. Application Data
(60) Provisional application No. 60/663,807, filed on Mar. 21, 2005.

(51) Int. Cl. G06F 11/00

(52) U.S. Cl. 714/38

(57) ABSTRACT

A method and software product for capturing decision data and generating JUnit/NUnit tests for each of a JAVA or C# code unit basis paths. The present software erects a user-interface for guiding a user through the basis paths in their source code and assisting them in creating the test data necessary to exercise each of those paths. At each decision in a given path, the software tells the user that the decision must evaluate either true or false to follow the current path, and it allows them to specify, select, or construct test data that will satisfy this condition. After the user has specified test data for all test paths, the software creates a new class containing a rewritten version of the user's original source code that allows test data to be injected at each decision while still preserving the overall control flow of the original code. The software then creates a complete JUnit or NUnit test suite to test each basis path from the original class in the new class by injecting the test data specified by the user.

### CROSS-REFERENCE TO RELATED APPLICATIONS

The present application derives priority from U.S. Provisional Patent Application 60/663,807 filed Mar. 21, 2005.

### BACKGROUND OF THE INVENTION

1. Field of the Invention

The present invention relates to software tools for unit testing of JAVA, C# and J++ code, and more particularly to a software tool compatible with Eclipse, JUnit and NUnit, that automates the unit test development process, actually performing a flow analysis of a unit of code, and using the information gathered by the analysis to generate a unit test set.

2. Description of the Background

Developers that write JAVA, C# and J++ code typically write and conduct “unit testing” to check their own code. JAVA is a well-known language, and C# code is an analogous language for the Microsoft .NET framework. .NET is a developer environment released in 2002 that is platform-independent for software development. The .NET framework is designed to provide support for any object-oriented programming language. Microsoft and other vendors provide .NET versions of many languages, including a Java and J++ (the Microsoft variant of Java) .NET transitional language. Eclipse is anotheropen-source, Java-based, extensible development platform most popular as a Java integrated development environment (IDE).

In all such cases unit testing helps to verify that a module of source code is working. A unit test is a method of testing the correctness of a particular module of source code. Unit testing differs from integration testing, which confirms that components work well together, and acceptance testing, which confirms that an application does what the customer expects it to do. Unit tests are so named because they test a single unit of code. In the case of Java, a unit usually equates to a single class or method. Proper unit testing code leads to higher-quality code, higher productivity, and lower maintenance and evolution costs. Unfortunately, unit testing can be very tedious. A complete testing effort requires software developers to create a detailed set of tests to exercise every possible outcome of their software. This is difficult for several reasons, it can be time-consuming for the developer to create individual tests, the process of creating a test suite is itself prone to errors, and it is easy for a developer to miss tests when constructing test suites by visual inspection of the code. There are tools to make it easier.

For example, Junit is an open-source unit test framework that has quickly become the de facto standard of the Java tests. Similarly, NUnit is the standard for the Microsoft .NET framework. To use either the JUnit or NUnit test frameworks, all a developer needs to do is to set up a minimal program structure, call the function being tested and compare the results of the call with the expected answer. The Eclipse 3,x environment also has integrated support for JUnit and supports launching Java unit tests from Eclipse and to view the test results. TestNG is another testing framework inspired from JUnit and Nunit. The Eclipse, JUnit and Nunit (as well as the TestNG) frameworks provide some assistance to a software developer. They allow developers to organize individual tests into logically-grouped suites that test a particular software module. Unfortunately, it is still up to the developer to define the test data that will drive a particular test. Developers typically do this in one of two ways:

1. Create the test data manually for each test. This is time-consuming and error-prone, and may be logically impossible altogether in the worst case of unrealizable test paths.

2. Run the existing test suites against new code in hopes of exercising a previously untested path. This method is haphazard, since it provides no guarantee that an untested path will be executed, and often leads to an inefficient test-analyze-retest cycle. There are typically many possible paths between the entry and exit of a program. Complete path coverage of even a simple unit test is extremely difficult. Testing, like all other development activities, takes time and effort. Thus, the design goal of testing is to select a set of test cases that is most likely to identify as many different potential defects as possible within those limits. It would be greatly advantageous to provide a software tool compatible with Eclipse, JUnit and NUnit, and TestNG, that automates the unit test development process, actually performing a flow analysis of a unit of code, and using the information gathered by the analysis to generate tests.

For purposes of the present description, the following IEEE/NIST definitions apply:

A Path through software is a sequence of instructions or statements that starts at an entry, junction, or decision and likewise ends at another.

An Independent Path is any path through the software that introduces at least one new set of processing statements or a new condition.

A Basis Path is a unique path through the software where no iterations are allowed.

Path Testing is that which is designed to execute all or selected paths through a computer program;

Branch Testing is that which is designed to execute each outcome of each decision point in a computer program;

Basis Path Testing is that which fulfills the requirements of branch testing and also tests all of the independent paths that could be used to construct any arbitrary path through the computer program. Basis path testing is mathematically more rigorous than branch or statement testing, as many defects are not found during branch and/or statement testing efforts. With basis path testing, combinations of decisions are tested, as opposed to individual lines of code or individual decisions.

Full automation of basis path testing is often impossible due to the diverse nature of software. For example, any given section of code might rely on user input, database accesses, or some other external data source outside the scope of an automated test-generation tool. It is possible to account for the fact that test data creation relies on a developer to set up an environment in which a particular test can be run.

Nevertheless, it would be greatly advantageous to provide a software tool with an intelligent analysis engine, and a user-interface for controlling the analysis engine that guides a user through the basis paths in their source code and assists them in creating the test data necessary to exercise each of those paths. This way, using the data provided by the user, it would be possible to create a suite of JUnit test cases for Java and NUnit test cases for C#, one test case for each basis path. A user need only run the generated JUnit and NUnit test suites, thereby testing each of the basis paths in their source code.

### SUMMARY OF THE INVENTION

It is, therefore, the primary object of the present invention to provide an improved software tool with an intelligent analysis engine, and a user-interface for controlling the analysis engine that guides a user through the basis paths in their source code and assists them in creating the test data necessary to exercise each of their code basis paths. By running the software tool a user easily generates JUnit and NUnit as well as TestNG test suites, and can test each of the basis paths in their source code.

It is another object to provide an improved software tool with a user-interface for controlling an analysis engine to generate test data despite code reliance on user input, database access, or any other external data source.

It is another object to provide an improved software tool for creating test data that ensures that a user's source code is fully basis-path tested.

It is still another object to provide an improved software tool for creating test data that does not require the user to manually determine a complete set of basis paths (an otherwise time-consuming process).

It is another object to provide an improved software tool for creating test data that generates a minimum number of tests required to fully test a class or method, ensuring that time required to execute a test suite is similarly minimal.

It is still another object to provide an improved software tool with the foregoing qualities as a plug-in to the existing Eclipse/JUnit/NUnit framework, which allows a user of that environment to test their software without invoking external tools that may not interface with Eclipse.

It is still another object to coordinate the creation and archiving of test data, which reduces the likelihood of errors on the user's part and facilitates re-use of existing test data for similar methods.

It is still another object to allow a user to run a pre-existing suite of unit tests and determine from the result all remaining independent paths necessary to complete a full basis set.

It is still another object to generate test data automatically, where feasible, such that the generated data satisfies the desired true or false outcome of any decision in a given basis path.

It is still another object to identify locations in any given basis path of the original source code where a null pointer could be referenced.

These and other objects are accomplished by a software product that semi-automatically generates test data for each of code unit's paths despite code that relies on user input, database access, or any other external data source outside the scope of an automated test-generation tool. The software product incorporates a method based on a new paradigm, recognizing the fact that test data creation relies on the developer to set up an environment in which a particular test can be run. The present software guides the user through the basis paths in their source code and assists them in creating the test data necessary to exercise each of those paths. Using the data provided by the user, the present software creates a suite of JUnit test cases for Java and NUnit test cases for C#, one test case for each basis path. Thus, by running the auto-generated JUnit and NUnit test suites, the developer tests each of the basis paths in their source code.

In accordance with the present method, the software first analyzes the user's source code and determines a set of basis paths for them to complete. It then presents an interface to the user that allows them to specify or construct test data that will satisfy the true and false outcomes of each decision (or to a specific constant value in the case of multi-way decisions) in those basis paths. Wherever possible, the software suggests test data to the user that satisfies the outcome of a given decision. Based on the foregoing the software then creates a new instrumented class that contains a rewritten version of the original source code that allows the software to inject the test data specified by the user in such a manner that the injected data exercises exactly one of the basis paths identified by the software. Finally, the software creates a complete JUnit test suite which, by injection of the user-defined data, tests all basis paths of the instrumented class, and, by extension, all the basis paths of the user's original source code.

The software design is simple and straightforward, highly effective and can be implemented for more efficient and effective unit testing of Java and C# code, leading to higher-quality code, higher productivity, and lower maintenance and evolution costs. Additional objectives, features and advantages will be apparent in the written description that follows.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a flow chart illustrating the steps followed by the software in order to generate the test path cases for their source code.

FIG. 2 is a screen print of the User Interface “CoView” window.

FIG. 3 is a flow chart illustrating the substeps of step 2 in FIG. 1.

FIG. 4 is a flow chart illustrating the substeps of step 4 of FIG. 2.

### DETAILED DESCRIPTION OF THE PREFERRED EMBODIMENTS

The present invention is a software program that generates JUnit and NUnit test cases for each code unit's paths. The present method adapts a new paradigm, recognizing that, while some automatic test data generation is feasible, test data creation overall relies on the developer to define test data for each basis path. The present software includes an intelligent analysis engine and a user-interface that controls the engine, guiding the user through the basis paths in their source code, and assisting them in creating the test data necessary to exercise each of those paths. The intelligent analysis engine analyzes the user's source code, and defines a set of basis paths that are to be tested. The software then presents a user interface that assists the user in creating data that tests each of those basis paths. At each decision in a given path, the software tells the user that the decision must evaluate either true or false to follow the current path (or to a specific constant value in the case of multi-way decisions), and allows them to specify, select, or construct test data that will satisfy this condition. After the user has specified test data (via the user interface) for all test paths of interest, the software creates a new class containing a rewritten (instrumented) version of the user's original source code. This allows the software to “inject” test data in such a manner that each injected data element exercises exactly one basis path of the original method. The software then generates a complete JUnit test suite to test the new class, and, by extension, all the basis paths of the original method. [Note to Joe: carefully review the sequence of steps as your changes suggest some inconsistencies. For example, I am now not sure whether the software creates a new instrumented version of code before or after the user has specified the test data] An exemplary embodiment is described configured as an Eclipse™ plug-in that is run from within an existing Eclipse program, and therefore requires a pre-installation of Eclipse™. The user must download and install Eclipse 3.1x. Once Eclipse is loaded, the present software is installed and started.

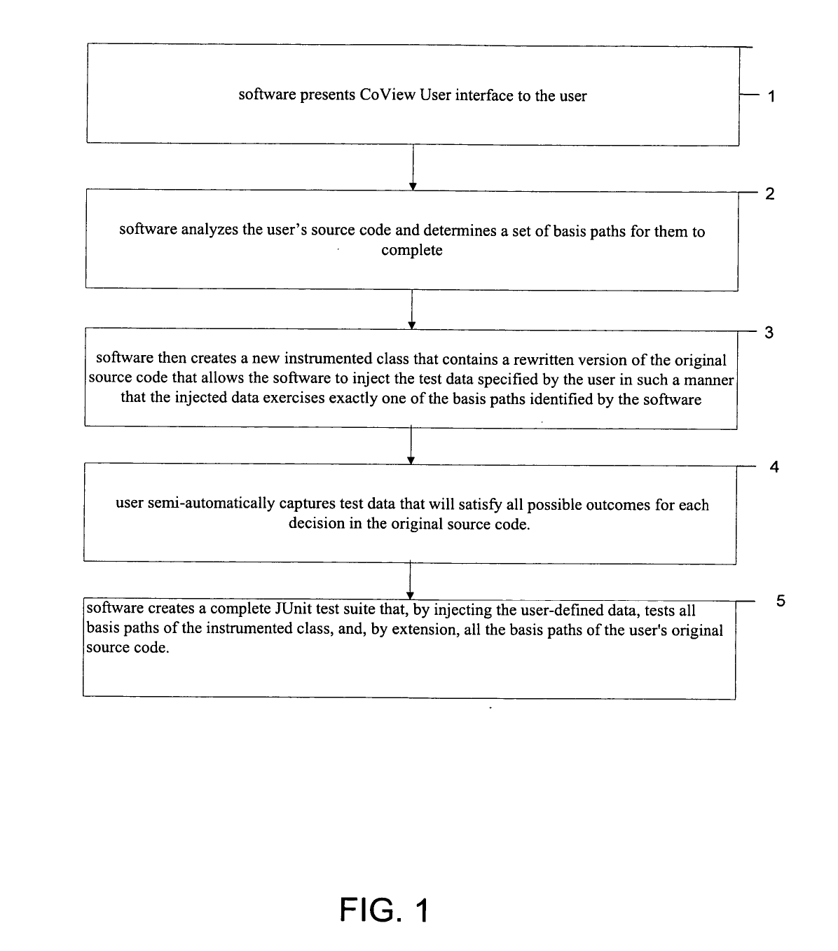

FIG. 1 is a flow chart illustrating the general steps followed by the present software method in order to generate the test path cases for given source code. The software is herein described in the context of a Java or C# developer using Eclipse.

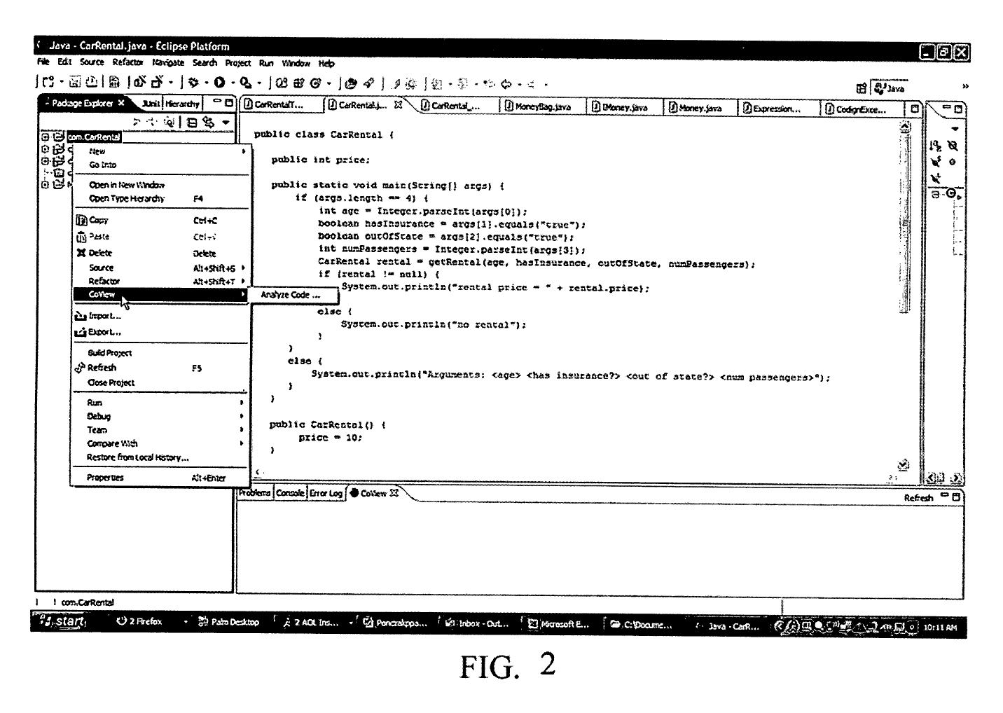

Immediately at Step 1, the software presents an interface to the user that generally allows them to specify or construct test data, and which automatically suggests test data whenever possible. The interface is entitled the CoView window, and a screen print of this is shown in FIG. 2. Te CoView window presents a simple tree-like navigation window for implementing the method steps (to be described). Selecting the menu item CoView>Analyze Code invokes the intelligent analysis engine.

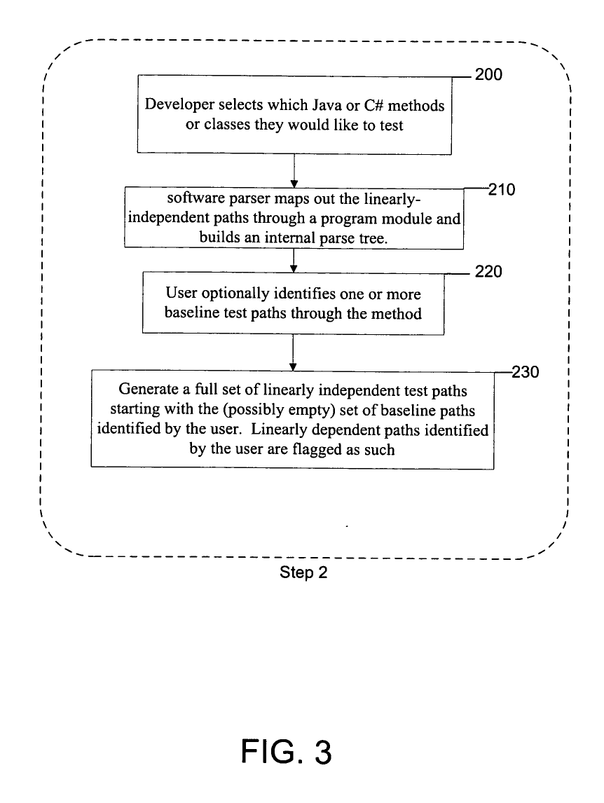

More specifically, at Step 2 the software analyzes the user's source code and determines a set of basis paths for them to complete. This entails the following substeps each of which is described in detail with regard to FIG. 3.

At substep 200 the developer selects which Java or C# methods or classes they would like to test. To do this, the user navigates within the CoView Explorer window (FIG. 2) to the desired object. An example of the class selection is set forth in Example 1 (see below).

At substep 210 the software parses the source code to identify decisions, exceptions, and all other code constructs. Parsing involves the procedure of bringing the basic code constructs into high-level relationships with one another. All code constructs are identified and characterized automatically, and the net result is a directed graph (a graph with directed edges e=(x, y) directed from the head x to the tail y). The parsing is accomplished by a software parser that dissects code into small units, then constructs and models basis paths based upon the decisions of the code, and builds an internal parse tree to model logic flow through source code. The parsing is automatic, and the net result is a full set of linearly independent test paths (see below). The parser is based on a known metric called “cyclomatic complexity” which has been adapted here for the creation of the JUnit/NUnit test cases. Cyclomatic complexity is a widely used static software introduced by Thomas McCabe in 1976 as a broad measure of soundness and confidence for a program by measuring the number of linearly-independent paths through a program module. For present purposes the software parser maps out the linearly-independent paths through a program module and builds the internal parse tree.

At step 220 the user optionally identifies one or more baseline test paths through the code. This is optional because the software will run without a user-defined baseline path.

At step 230 the software parses the entire unit code subject to user input at step 220, and generates a full set of linearly independent test paths. If designated in step 220, step 230 begins with the set of baseline paths identified by the user; otherwise, the software generates a baseline path by following the flow of control through the method and selecting the “true” for the outcome of each decision encountered in the source code. Any linearly dependent paths identified by the user are flagged as such. Any paths that contain potential data dependencies will be flagged, allowing the user to ignore or rewrite those paths. Any paths that contain a possible use of a null object reference (a “null pointer”) will be flagged, indicating a possible source of trouble to the user.

Referring back to FIG. 1, at step 3, the software then creates a new class that contains an “instrumented” version of the original source code. The instrumented code contains the original source code plus additional statements (“handles”) added by the software which will allow the software to “inject” specific values during later testing that will force the flow of control along specific decision outcomes. The instrumented class will, by default, be inherited from the original class, but in the case of private or final code constructs it may be necessary to incorporate unmodified units of the original source code into the instrumented code.

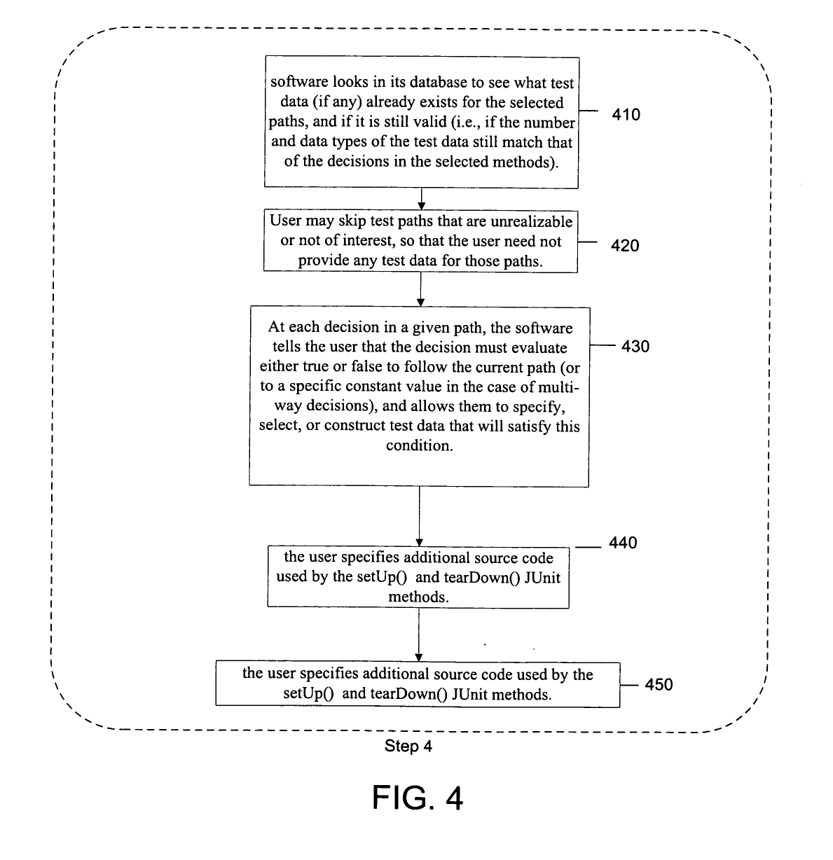

At step 4, the user captures test data that will satisfy all possible outcomes for each decision in the original source code. This is done semi-automatically. The software provides default test data values where possible, but where complex objects are required, the software solicits from the user the code necessary to create these objects. All test data is saved in a SQL database for future use. This allows the user to re-use previously defined objects to satisfy multiple decision outcomes. The software also allows the user to skip test paths that are unrealizable or not of interest, so that the user need not provide any test data for those paths. If the user changes their source code, the software automatically detects any previously-captured test data that is no longer valid. Thus, as the user changes their source code, the software requires new test data for the decisions that have changed. The specific substeps of step 4 are shown in FIG. 4.

At substep 410 the software looks in its database to see what test data (if any) already exists for the selected paths, and if it is still valid (i.e., if the number and data types of the test data still match that of the decisions in the selected methods).

At substep 420, the user may skip test paths that are unrealizable or not of interest, so that the user need not provide any test data for those paths.

[any other pre-construction substeps?]

At substep 430, the software (via the user interface) guides the user down through the source code and helps them to establish test data that exercises each basis path. At each decision or “condition” in a given path, the software tells the user that the decision must evaluate either true or false to follow the current path (or to a specific constant value in the case of multi-way decisions), and allows them to specify, select, or construct test data that will satisfy this condition. This allows the user to specify arguments necessary to invoke the method under test.

At substep 440, the software allows the user to specify additional source code used by the setUp( ) and tearDown( ) JUnit methods.

At substep 450, the software allows the user to specify post-test assertions used to verify that the user's software under test performed correctly. Typically these are done via JUnit's various assert( ) methods.

Referring back to FIG. 1, at step 5, after the instrumented code has been generated and all necessary test data has been captured, the software will define a new JUnit test case for the original class. The JUnit test case contains one method for each test path (include user-defined paths) from all methods in the original class. Each JUnit test injects into the instrumented source code the specific data values captured in step 600. Thus, JUnit tests are generated for each basis path of the original method. This is accomplished automatically, the software generating Junit tests to call the methods in this new class.

The present software has now done its job, and the developer has a complete JUnit test suite to test the new unit of code. The following is a functional example of the above-described method.

### EXAMPLE 1

At step 1, the software presents the CoView User interface, and at step 2, the software analyzes the user's source code and determines a set of basis paths for them to complete. This begins at substep 200, where the developer selects which Java or C# methods or classes they would like to test. Assume that the developer selects the following class and its single method:

```
class Math {
    public int sign(int x) {
      int rv;
      if (x > 0) {
          rv = 1;
      }
      else if (x < 0) {
          rv = −1;
      }
      else {
          rv = 0;
      }
      return rv;
    }
}
```

At substep 210 the software parses the methods to identify decisions, exceptions, and all other code constructs, and optionally at substep 220 the user can identify one or more baseline test paths through the code. In this example we will assume that the manual selection is bypassed and the software runs without any user-defined paths.

At substep 230 the software parses the entire unit code and generates a full set of linearly independent test paths All test data previously saved by the user (assuming that data is still valid) may be reused

Referring back to FIG. 1, at step 3 the software creates a new instrumented class that contains a rewritten version of the original source code that allows the software to inject the test data specified by the user in such a manner that the injected data exercises exactly one of the basis paths identified by the software. For example:

```
class Codign_Math {
  public int sign(int x){
    int rv;
    if ((x = getInjectedValue(“x”, x) > 0) {
      rv = 1;
    }
    else if ((x = getInjectedValue(“x”, x) < 0) {
      rv = −1;
    }
    else {
      rv = 0;
    }
  return rv;
}
```

At step 4, for each test path that requires test data, the software helps the user to specify data that forces each decision outcome to be either true or false, as required for that particular test path. In this example case above at step 4 three basis paths through the method are identified as T (path 1), FT (path 2), and FF (path 3). Consequently, the software prompts the user to enter values for the three paths T (path 1), FT (path 2), and FF (path 3). Where feasible, the software will suggest possible values for the necessary test data (see FIG. 4, substep 430), but the user is always free to override them. For example, a user might specify the following values for x to satisfy the conditions of each test path:
Path 1 (T): x=10
Path 2 (FT): x=−3
Path 3 (FF): x=0

Finally, at step 5 (FIG. 1), using the instrumented class created in step 500, the present software then generates the following test suite for JUnit:

```
public class Codign_signTestCase extends TestCase {
  Codign_Math codign_math = null;
  public void setUp( ) {
    codign_math = new Codign_Math( );
  }
  public void tearDown( ) {
    codign_math = null;
  }
  public void testsign_CodignPath1( ) {
    setInjectedValue(“x”, 10);
    int rv = codign_math.sign(0);
    assertEquals(rv, 1);
  }
  public void testsign_CodignPath2( ) {
    setInjectedValue(“x”, −3);
    int rv = codign_math.sign(0);
    assertEquals(rv, −1);
  }
  public void testsign_CodignPath3( ) {
    setInjectedValue(“x”, 0);
    int rv = codign_math.sign(0);
    assertEquals(rv, 0);
  }
}
```

Note that in the foregoing example, the parameters passed to the sign( ) method really make no difference since the injected values in the rewritten code in each method forces the flow down a particular path. After completing this test suite, all three paths in the instrumented sign( ) methods will have been tested; and therefore all three paths of the original sign( ) method will have been tested, as well.

The exact same process as described above is applied to C# NUnit test creation as well. It should now be apparent that the foregoing software accomplishes specific goals:

1. It ensures that the user's source code is fully basis-path tested. Basis path testing is mathematically more rigorous than branch or statement testing, and thus provides a higher degree of security and reliability.

2. It does not require the user to manually determine a complete set of basis paths, which is a time-consuming process.

3. It generates the minimum number of tests required to fully test a module, ensuring that time required to execute a test suite is similarly minimal.

4. It is a plugin to the existing Eclipse/JUnit/NUnit framework, which allows a user of that environment to test their software without invoking external tools that may not interface with Eclipse.

5. It coordinates the creation and archival of test data, which reduces the likelihood of errors on the user's part and facilitates re-use of existing test data for similar methods

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept It is to be understood, therefore, that the invention may be practiced otherwise than as specifically set forth in the appended claims.

We claim:

1. A method for generating JUnit tests for each of a JAVA or C# code unit basis paths, comprising the steps of:
providing a user-interface for manual selection of which Java or C# code unit a user would like to test;
providing a database to store test data for the selected code unit;
automatically parsing the selected code unit to identify all code constructs therein;
automatically parsing the selected code and generating a full set of linearly independent test executing a look-up to said database to determine what test data, if any, already exist for the selected code unit and if it is still valid;
providing a user-interface to guide the user through their code and prompting them to specify data that will force each decision outcome to be either true or false, as required for each identified test path;
updating said database with said specified data;
automatically creating a new class that contains one new method for each test path being tested;
creating a complete JUnit/NUnit test suite that tests the new class and all basis paths therein.

2. The method for generating JUnit tests for each of a JAVA or C# code according to claim 1, wherein said step of creating a complete Junit/NUnit test suite includes creating one test case for each basis path.

3. The method for generating JUnit tests for each of a JAVA or C# code according to claim 1, wherein said step of providing a user-interface to guide the user through their code and prompting them to specify includes, at each condition in a given path, telling the user via the guided user interface that the condition must evaluate either true, false, or a specific constant value for each decision along a basis path, and allowing them to specify, select, or construct test data that will satisfy this condition.

4. A method for generating basis paths tests for source code, comprising the steps of:
presenting a graphical user interface to a user;
applying an analysis engine to automatically analyze original source code and establish a set of basis paths;
generating an instrumented class including a rewritten version of said original source code;
guiding said user through the basis paths of said source code and generating test data therefore by allowing said user to specify test data, select a condition, construct test data, or skip each basis path, in each case suggesting test data to said user;
creating a complete basis path test suite that, by injecting of said generated test data, tests all basis paths of the instrumented class, and, by extension, all the basis paths of the original source code.

5. The method for generating basis paths tests for source code according to claim 4, wherein said step of completing a complete basis path test suite comprises a JUnit/NUnit test suite with one test case for each basis path.

6. The method for generating basis paths tests for source code according to claim 4, wherein said step of guiding said user through the basis paths of said source code and generating test data therefore comprises using said user-interface to guide the user through each vasis path in the code, telling the user via the guided user interface that each condition along each basis path must evaluate either true, false, or a specific constant value, and prompting the user to specify, select, or construct test data that will satisfy each condition.

7. A software product for generating basis paths tests for source code, comprising:
an intelligent analysis engine for analyzing a user's source code and defining a set of basis paths to be tested; and
a graphical user-interface for guiding the user through the defined basis paths in said source code and assisting them in creating tests necessary to exercise each defined basis path; and
a test generator for automatically generating a set of tests to exercise each defined basis path;
whereby by running the automatically-generated tests, the developer tests each of the basis paths in their source code.

8. The software product for generating basis paths tests for source code according to claim 7, configured to operate as a plugin to an existing Eclipse/JUnit/NUnit framework.
